(19) United States
(12) Patent Application Publication
(10) Pub. No.: US 2009/0152429 A1
(43) Pub. Date: Jun. 18, 2009

(54) Post Support

(75) Inventor: James David Francis West, Mona Vale (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Bluedog Fences Australia Holdings Pty Limited, Mona Vale (AU)

(21) Appl. No.: 11/957,382

(22) Filed: Dec. 14, 2007

(51) Int. Cl. F16M 13/02

(52) U.S. Cl. 248/351

(57) ABSTRACT

The invention provides a post support including means for contacting a surface in or on which the post is to be set. The post support has brace means for contacting the post and hook means for embracing the post. The invention also provides a post support system having two or more post supports, and a method of supporting a post in a chosen position.

### BACKGROUND OF THE INVENTION

This invention relates to a post support. In particular, the invention concerns the type of support which may be used to support a post while it is being secured in, for example, the ground.

In the description below, for convenience, reference will be made to posts intended to form parts of fences. It is to be understood, however, that the scope of the invention is not limited in this respect. The post support of the invention may be used in connection with any suitable type of post, including light poles, flag poles, building columns and the like, as well as fence posts.

Commonly, fence posts are secured in the ground by the use of concrete. Single posts may be secured by a base of concrete limited to the area around the foot of the post. Where a number of posts is involved and a high degree of stability or security is required, a concrete footing, for example formed in a trench, may be included.

As is well known, concrete requires setting time. Consequently, it is necessary to maintain each post in a fixed position while the concrete is setting or curing to a sufficient extent to hold the post permanently in position. Prior to the present invention, various methods have been devised to hold posts in position in this way. For example, clamping systems, combined with props have been used in the past. These and other prior art systems have suffered from one or more problems, for example: the support system is labor intensive and time consuming to construct; the support system requires two or more workmen (one to hold the post in position and other/s to construct the clamp and prop or other support system); the system is not easily reusable since most require assembly and disassembly after the post has been set; some systems do not suspend the post above the ground (which is desirable if the concrete is to be poured so that it sits under the post, so that a metal post will not rust); prior art systems may not easily allow for changes in levels of the terrain around the post; and it is not easy to make adjustments to the post as to height and angle.

### BRIEF SUMMARY OF THE INVENTION

It is an object of the present invention to alleviate some or all of the problems found with prior art systems. In particular, it is an object of the present invention to provide a post support which, at least in some embodiments: can enable fast and easy post support; can enable a post to be adjusted to the correct position by a single workman; is readily reusable and transportable; can permit a post to be held free of the ground so that concrete can be poured underneath the post; can readily adjust for changes in terrain levels; and may permit relatively simple and fast adjustment as to height or angle.

The invention provides a post support including means for contacting a surface in or on which the post is to be set; brace means for contacting the post; and hook means for embracing the post. Optionally, the means for contacting the surface includes a leg, having a surface-contacting end and a post-contacting end. Optionally, the leg is either substantially linear or forms an angle having, in use, a substantially horizontal part and a substantially vertical part. Optionally, the brace means and the hook means are formed as part of or are connected to the post-contacting end. Optionally, the brace means and the hook means are combined in a unitary structure. Optionally, the brace means and the hook means are in use either substantially horizontal or inclined at an acute angle to the vertical.

The invention further provides a post support system including a plurality of post supports as described above. Optionally, there are three of the post supports, each having a leg which forms an angle and having, in use, a substantially horizontal part and a substantially vertical part. Optionally, each of the three post supports has a vertical part of a different length. Optionally, one of the post supports has brace means and hook means which are a mirror reverse of another. Optionally, there are two of the post supports, one having a leg which is substantially linear and the other having a leg which forms an angle and having, in use, a substantially horizontal part and a substantially vertical part. Optionally, one of the post supports has brace means and hook means which is different from those of the other. Optionally, the post support system includes a third post support having a leg which is substantially linear.

The invention further provides a method of supporting a post in a chosen position including the steps of: holding the post in a position similar to the chosen position; attaching to the post a plurality of post supports as described above; tilting the post away from one of the post supports while the post is still supported by the other post support or supports, to move the post closer to the chosen position; adjusting the height of the post to that of the chosen position and restoring the post to attachment by the one post support; and adjusting the surface contacting means of the post supports until the post is in the chosen position.

### BRIEF DESCRIPTION OF THE DRAWINGS

The invention will now be described in connection with various non-limiting embodiments illustrated in the accompanying drawings, in which:

FIG. 1 is an isometric schematic view of a first embodiment of a post system of the invention, showing two embodiments of post supports of the invention;

FIG. 2 is a side view of the embodiment of FIG. 1;

FIG. 3 is an end view of the embodiment of FIG. 1;

FIG. 4 is a top view of the embodiment of FIG. 1;

FIG. 5 is an isometric view of one of the post supports of the system of FIG. 1;

FIG. 6 is a top view of part of the post support of FIG. 5;

FIG. 7 is an isometric view of another of the post supports of FIG. 1;

FIG. 8 is a top view of part of the post support of FIG. 7;

FIG. 9 is a schematic isometric view of a second embodiment of the post system of the invention, showing further embodiments of post supports of the invention;

FIG. 10 is an end view of the embodiment of FIG. 9, looking in the direction of arrow A in FIG. 9;

FIG. 11 is a side view of the embodiment of FIG. 9;

FIG. 12 is a top view of the embodiment of FIG. 9;

FIG. 13 is an isometric view of an embodiment of post support, being the lowermost post support illustrated in FIG. 9, omitting the brace means and the hook means;

FIG. 14 shows the reverse side of the post support of FIG. 13;

FIG. 15 shows in plan view a unitary structure combining brace means and hook means for the post support of FIG. 13;

FIG. 16 is an isometric view of a further embodiment of post support, being the topmost post support illustrated in FIG. 11, but omitting brace means and hook means;

FIG. 17 shows the reverse side of the post support of FIG. 16;

FIG. 18 is a plan view of a unitary structure being a combined brace means and hook means for the post support of FIG. 16;

FIG. 19 is a schematic isometric view of a series of fence posts with a third embodiment of the post support system of the invention; and

FIG. 20 shows the fence in FIG. 19 with the post support systems of the invention removed.

### DETAILED DESCRIPTION OF THE INVENTION

Accordingly, this invention provides a post support including: means for contacting a surface in or on which the post is to be set; brace means for contacting the post; and hook means for embracing the post.

The post may be of any desired length, cross sectional shape or material. Commonly, fence posts are made of timber and are square or rectangular in cross section or are made of steel and are RHS (rectangular hollow section) or L-, U-, or C-shaped in cross section. The invention is not limited to these shapes. For example, the post support of the invention may be used to support a post which is circular in cross section. If necessary, an adaptor, for example, a sleeve, may be used with the post support of the invention. The sleeve is preferably in two parts for positioning loosely around the post using, for example, a cable tie.

The surface in or on which the post is to be set will normally be earth, but the invention is not limited in this respect. For example, the post support of the invention may be used to support a post which is being set on an existing manufactured surface.

The post will commonly be set vertically in or on the surface. However, it is within the scope of the invention that the post is to be set at an angle to the vertical.

The means for contacting the surface can take several different forms. Preferably, the means is a leg. In this embodiment, it is preferred that the leg takes one of two conformations. In the first conformation, the leg is essentially linear, being intended to support the post with the leg at an angle to the surface. This form of leg may have a surface-contacting end and a post-contacting end. The surface-contacting end is preferably cut or formed so that it is generally parallel to the surface it is intended to contact. However, the leg may include at the surface-contacting end an enlarged base or flange.

In the second preferred embodiment of the leg, the leg forms an angle, having a generally vertical first part and a generally horizontal second part. In this embodiment, the generally vertical first part is intended to contact the surface in or on which the post is to be set while the generally horizontal second part ends in the brace and hook means. The generally vertical first part may have an enlarged base or flange for contacting the surface.

The leg may be made of any suitable material, including timber and steel.

The brace means and the hook means are preferably formed as part of or connected to the means for contacting the surface at one end thereof, being the end opposite to the surface contacting end. The brace means and the hook means are preferably steel but other materials may be suitable. The brace means and the hook means may be combined in a unitary structure or they may be provided separately on the surface contacting means.

The brace means is intended in use to bear against the post while the hook means is intended to retain the post in engagement with the brace means. As will be appreciated from the description of preferred embodiments (below) in connection with the accompanying drawings, in some embodiments the brace means and the hook means are intended to be substantially horizontal in use and hence substantially perpendicular to the post when the post is to be set vertically. In other embodiments, the brace means and the hook means may be intended to be inclined at an acute angle to the vertical in use.

Where the brace means and/or the hook means are not formed with but are connected to the surface contacting means, the connection may take any suitable form. For example, the brace means and/or the hook means may be welded to the surface contacting means or may be retained in slots. Other connections will be apparent to one skilled in the art.

The post support of the invention is preferably combined with one or more (preferably two) other post supports of the invention. Accordingly, this invention also provide a post support system which includes a plurality of post supports of the invention.

The invention also provides a method of supporting a post in a chosen position including the steps of:
(a) holding the post in a position similar to the chosen position;
(b) attaching to the post a plurality of post supports of the invention;
(c) tilting the post away from one of the post supports while the post is still supported by the other post support or supports, to move the post closer to the chosen position;
(d) adjusting the height of the post to that of the chosen position and restoring the post to attachment by the one post support; and
(e) adjusting the surface contacting means of the post supports until the post is in the chosen position.

The post support system of the invention in an especially preferred embodiment has three of the post supports. Preferably, these are provided with differently-sized legs, so that in use the post supports of the invention will contact the post at three different levels.

In the embodiment of the post support of the invention where the leg forms a substantially right angle, it is preferred that the part of the leg which is vertical in use is of relatively short length for the first post support of the post support system, of relatively medium length for the second post support and of relatively long length for the third post support. It is further preferred that the three post supports are adapted to contact the post spaced at approximately 120°. The purpose of this is to provide optimum stability to the post while any concrete poured around the post base is setting.

In this embodiment of the three-post support system, it is preferred that the brace means and the hook means are provided separately on each leg. It is further preferred that the brace means and the hook means on two of the post supports are substantially identical (one being a mirror reverse of the other). Preferably, the uppermost and middle legs have identical brace means and hook means, while the lowermost leg has a different configuration of brace means and hook means. An example of this is given in connection with the drawings, described below.

This configuration can facilitate manipulation of the post supports and the post. A single workman can handle a post, including one as heavy as 65 kilograms and as long as 4 metres. Each of the three post supports can be hooked onto the post, the workmen holding the post vertical with one hand and hooking on the post supports with the other. Once the three post supports are roughly attached, the workman may take the weight of the post and tilt it a little so that it is supported by the middle and lower post supports, leaving the uppermost, third post support free from weight. The workman can adjust the height of the post while it is suspended above the ground. Adjustments can be made to the horizontal plane by pushing and pulling the three post supports around on the surface (usually the ground). The workman may use a spirit level or a laser leveling device to ensure that the post is supported in the desired position.

In a second preferred embodiment, the post support system of the invention has three post supports, similar to the previous embodiment described above. However, in the case of the second embodiment the means for contacting the surface are of two types. The lowermost post support has a leg which is right angled while the middle and uppermost post supports have linear legs which in use are inclined at an angle to the post. Preferably, the legs are made of timber and the brace means are integral with the legs. A timber brace means can be kinder to a post surface, especially if powder coated.

In this embodiment, in the case of all three legs, the cancelled brace means and the hook means are provided separately, preferably as a steel plate which can be disassembled from the legs for packing and storage. In this embodiment, it is preferred that the uppermost and middle post support hook means are identical while the plate on the lowermost leg is different. It is also preferred that the plates for the uppermost and middle legs are adapted to be substantially horizontal in use, while the plate for the lowermost leg is adapted to be inclined at an acute angle to the post in use.

Preferably, in this embodiment the plates are mounted on the legs in grooves provided for that purpose. While the plates are preferably steel, the legs may be made out of a different material, such as timber.

Once again, where there are three post supports, it is preferred that they are adapted to contact the post spaced at approximately 120°.

In a third embodiment, the post support system of the invention has only two post supports. This post support system may be useful in a situation where, for example, a fence post to be set in the surface is already partially supported by one or more fence rails situated between the post to be supported and an adjacent post. While the post supports in this third embodiment may take various forms, it is preferred that they resemble the post supports used as the middle and lowermost post supports in the previous embodiment, provided the post is partially supported by a rail situated at a level lower than the post supports in use.

In the embodiment of the post support of the invention where the leg is substantially linear, it is preferred that in the post support system of the invention there are at least two of the post supports, one having a longer leg than the other. Optionally, in this embodiment there may be a third post support but preferably this has an angled leg if it is to be lowermost. The purpose of this is to ensure that the point of contact with the ground is towards the end of the leg. The strength of the “grip” couple provided by the brace means and the hook means to the post is directly proportional to the distance from the post that vertical reaction force from the ground is imported to the leg.

Where the post support system of the invention has only two post supports, it is preferred that identical brace means and hook means are provided, with the first brace means and hook means being a mirror reverse of the second.

In an embodiment of the post support system of the invention which has a third post support with an angled leg, it is preferred that the brace means and hook means of the third leg is different from those of the first and second legs.

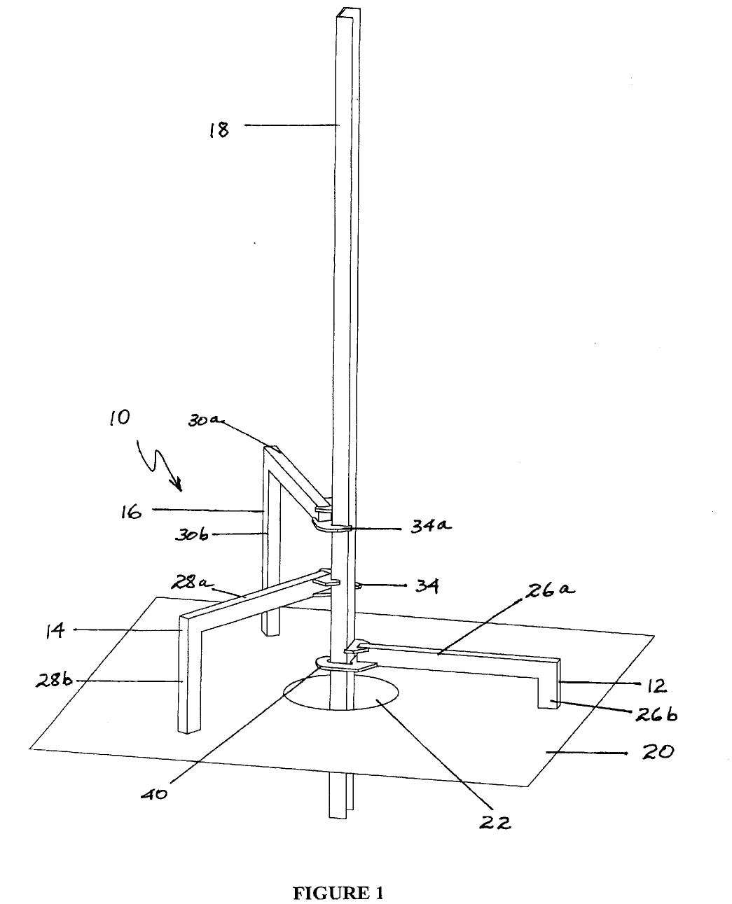

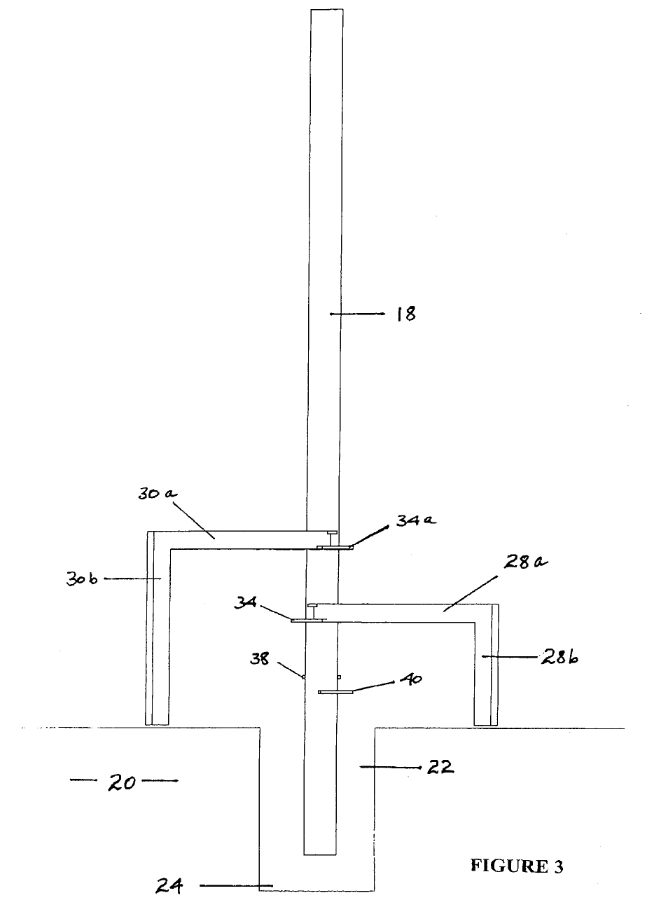

It will be appreciated that the drawings are of various scales. Referring first to the embodiment of the post support system in FIGS. 1 to 4, post support system 10 in this embodiment has three post supports 12 (lowermost), 14 (middle) and 16 (uppermost) for supporting post 18. Post 18 is rectangular in cross section except that one side is open, so that it may be regarded as being C-shaped or U-shaped in cross section. In this embodiment, post 18 is approximately four metres long and weighs approximately 65 kilograms. Post 18 is galvanized steel.

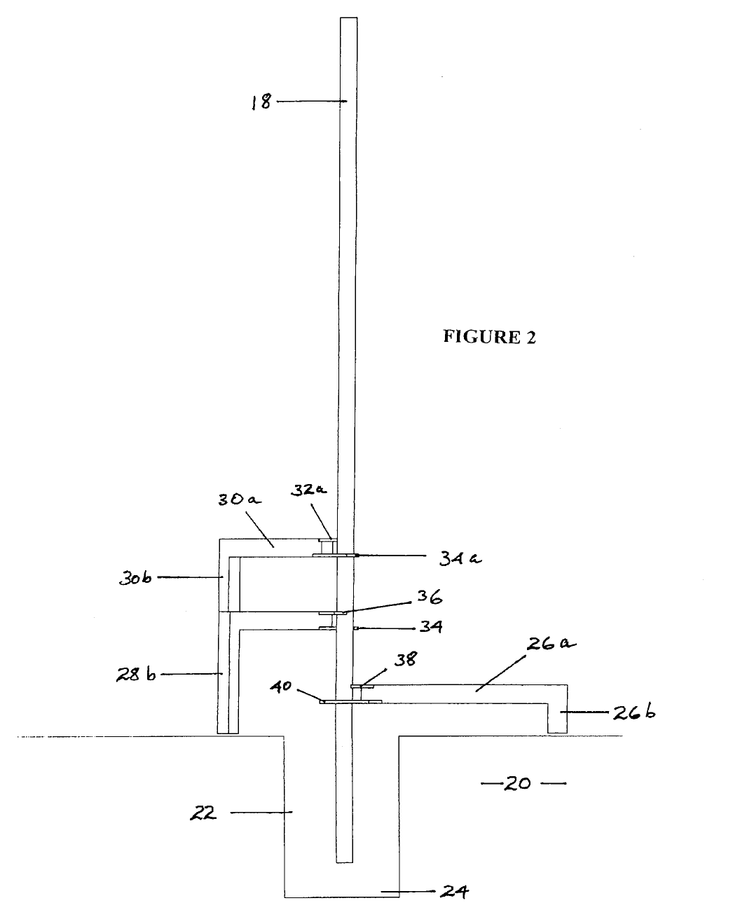

Post 18 is to be supported in ground 20 while concrete (not shown) poured into hole 22 is setting or curing. As can be seen from FIG. 2, post 18 is held above the base 24 of hole 22, so that when concrete is poured into hole 22, concrete beneath post 18 will insulate post 18 from the earth and provide a pad or base of support for the weight of post 18 and assist in avoiding rust.

As can be seen from FIGS. 1 to 3, each of post supports 12, 14 and 16 has a leg 26, 28 and 30, respectively. Each leg has a generally horizontal part (26a, 28a and 30a) and a generally vertical part (26b, 28b and 30b). In the embodiment illustrated, the horizontal parts 26a, 28a and 30a are of approximately the same dimension. The vertical parts, however, vary. Part 30b is the longest, part 26b is the shortest and 28b is intermediate the other two. This gives the three different heights for post supports 12, 14 and 16 so that they support post 18 at the spaced intervals and allows for some unevenness in ground levels.

Although the Figures show post 18 standing vertically, post supports 12, 14 and 16 are capable of holding post 18 in a slanted position, provided the centre of gravity of post 18 lies within a triangle connecting the three points where vertical parts 26b, 28b and 30b touch the ground.

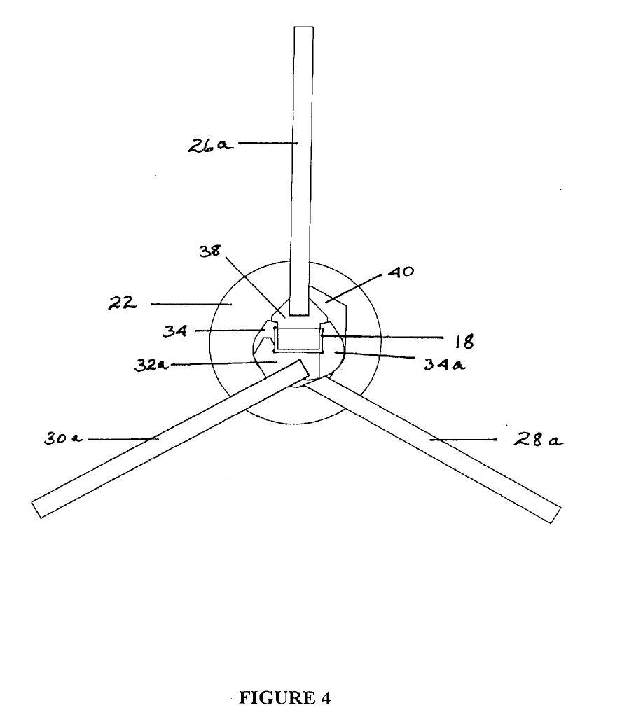

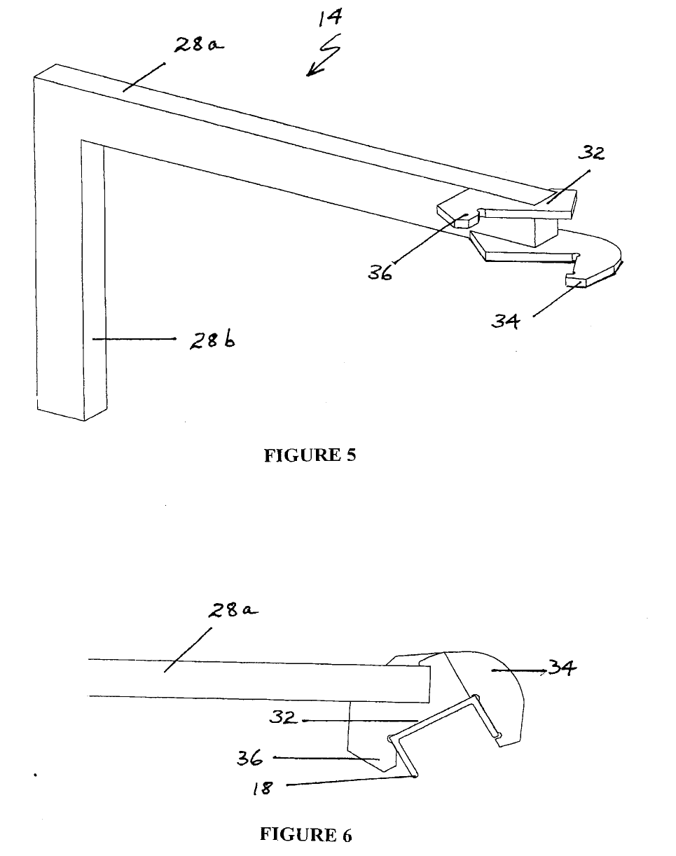

FIG. 5 shows middle post support 14, having brace means 32 and hook means 34. (Upper post support 16 has brace means 32a and hook means 34a which are the same but mirror reversed). Brace means 32 is formed integrally with a second optional hook means 36 (refer corresponding second hook means 36a on upper post support 16 in FIG. 4). As can be seen in FIG. 6, brace means 32 bears against post 18 while hook means 34 embraces it. Second hook means 36 enhances the embracing of post 18 by post support 14.

FIG. 4 shows the way in which post 18 is supported and stabilized by post support system 10. In this embodiment, post 18 is U- or C-shaped in cross section. As indicated above, other post profiles can be accommodated by the post support and post support system of the invention. Although not illustrated, if post 18 is circular in cross section, an adaptor can be added to a circular post 18. The adaptor would be in the form of a two-part sleeve to encompass the area from above upper post support 16 to below lower post support 12 in FIG. 1. The adaptor would have an inner surface which would be circular. The external surface of the or each adaptor would present to brace means 32 and hook means 34 as a square or rectangle. The sleeve would be loosely positioned on post 12 using cable ties or the like. The clamping effect of brace means 32 and hook means 34 would firmly sandwich the sleeve during operation.

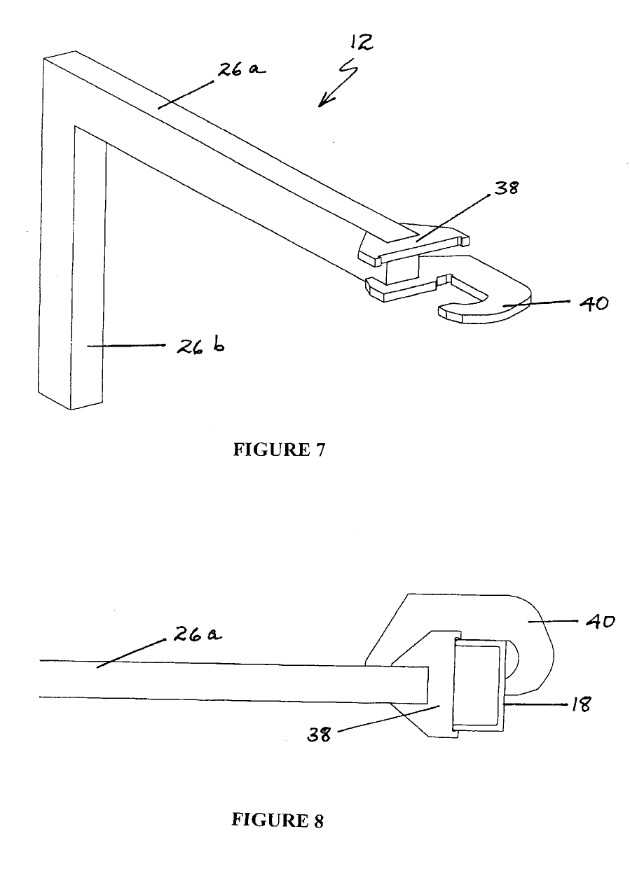

FIG. 7 illustrates lower post support 12 having brace means 38 and hook means 40. FIG. 8 shows how hook means 40 embraces post 18 and how brace means 38 bears against the open end of post 18.

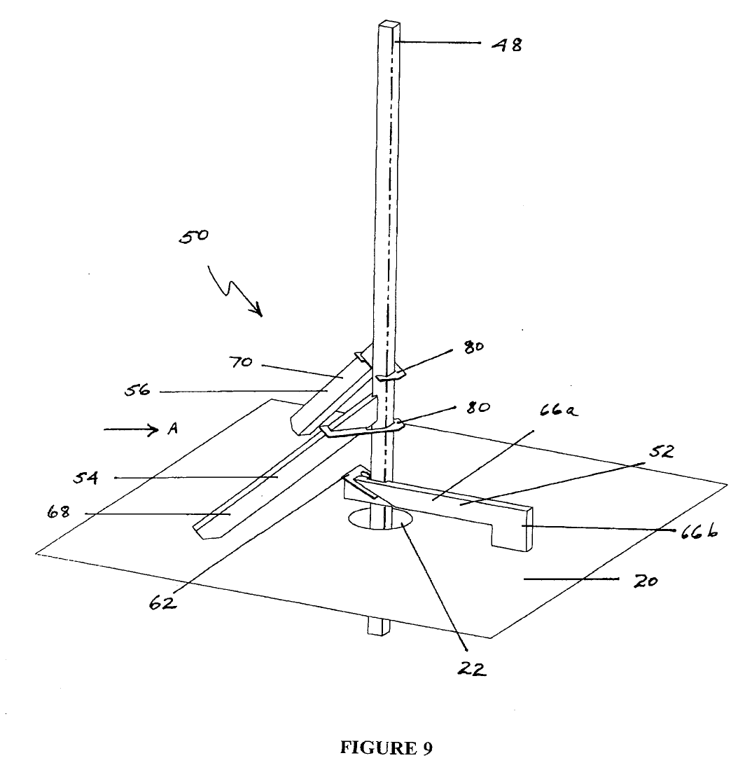

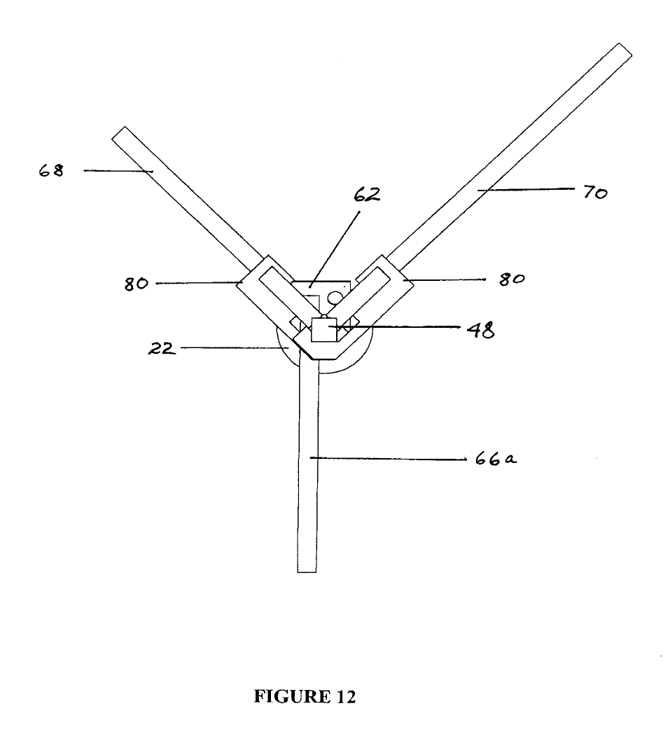

The second embodiment of the three-post system is illustrated in FIGS. 9 to 12. Post support system 50 in this embodiment has three post supports 52 (lowermost), 54 (middle) and 56 (uppermost) for supporting post 48. Post 48 is square and is made of steel.

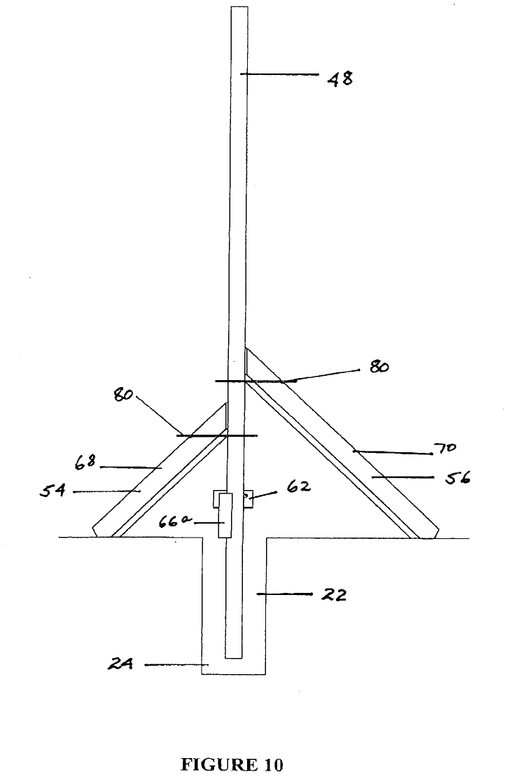

Post 48 is to be supported in ground 20 while concrete (not shown) poured into hole 22 is setting or curing. As can be seen from FIG. 10, post 48 is held above the base 24 of hole 22, so that when concrete is poured into hole 22, concrete beneath post 48 will insulate post 48 from the earth and assist in avoiding rotting.

As can be seen from FIGS. 9 to 11, each of post supports 52, 54 and 56 has a leg 66, 68 and 70, respectively. Lowermost leg 66 has a generally horizontal part 66a and a generally vertical part 66b. Legs 68 and 70, however, are substantially linear, leg 70 being longer than leg 68. Post supports 52, 54 and 56 are of three different heights, so that they support post 18 at the spaced intervals.

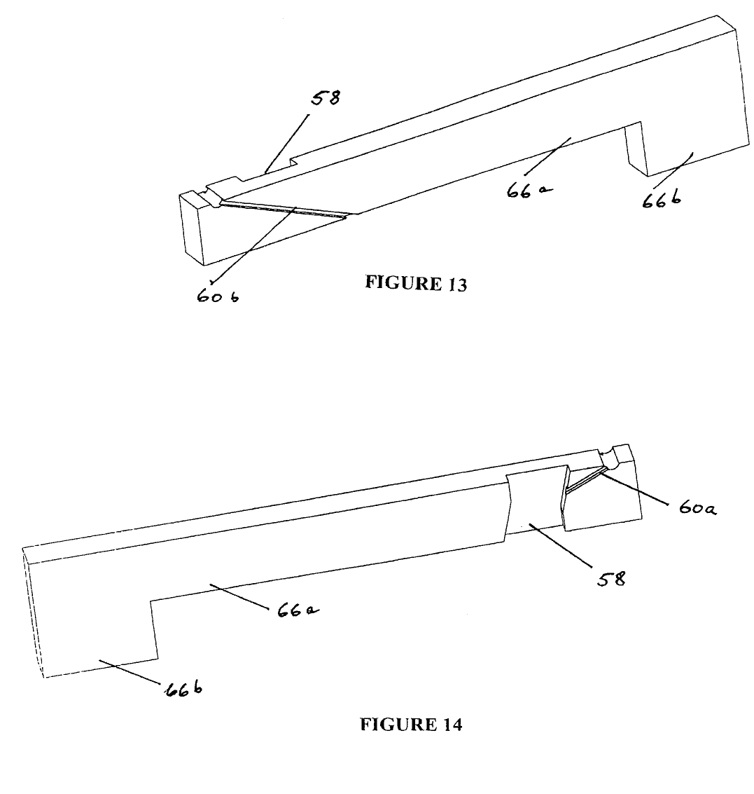

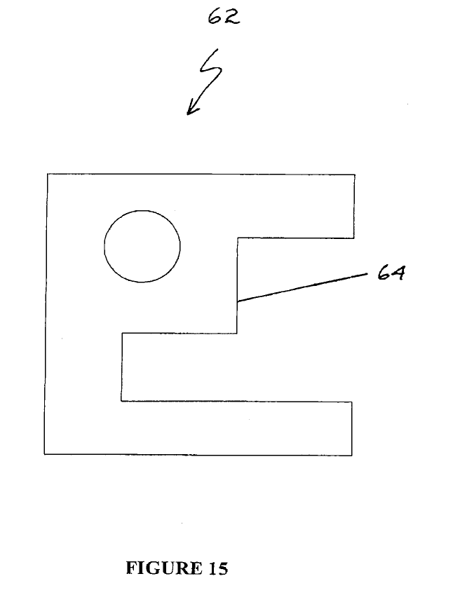

FIGS. 13 and 14 show two views of lowermost leg 66. Integral with leg 66 is cut-out 58 designed to embrace post 48 and act as the hook means. Leg 66 includes grooves 60a and 60b to accommodate plate 62 (FIG. 15), which has part 64 to help brace post 48. As can be seen in FIGS. 9 to 11, when plate 62 is mounted in groove 60 on leg 66, plate 62 is at an angle to post 48.

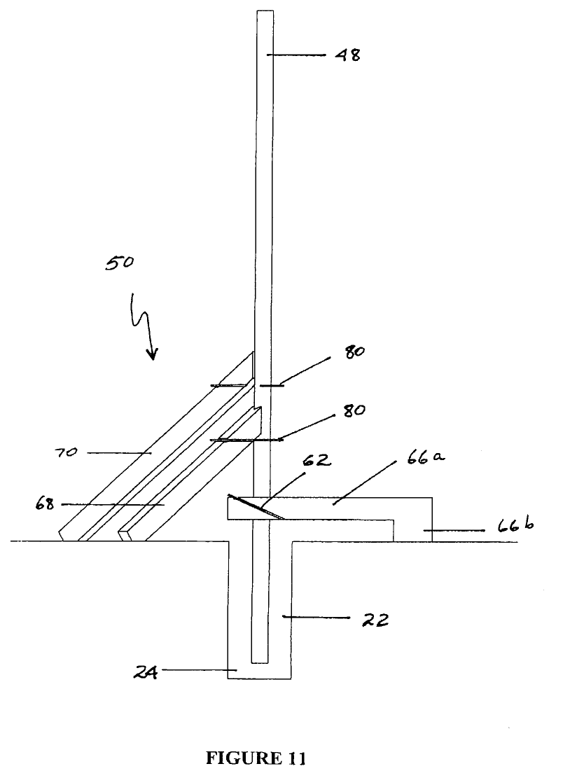

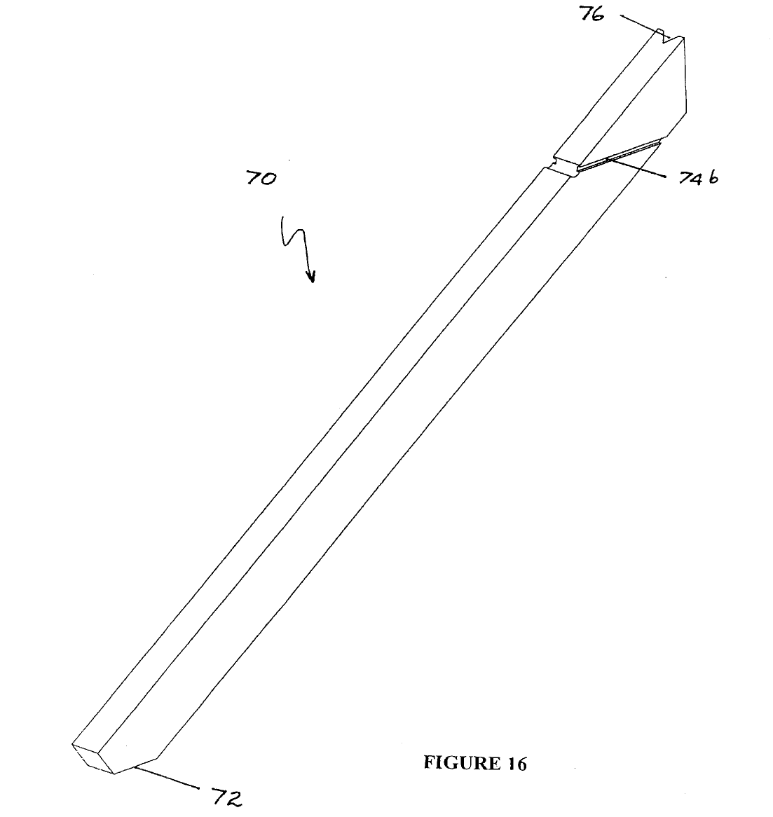

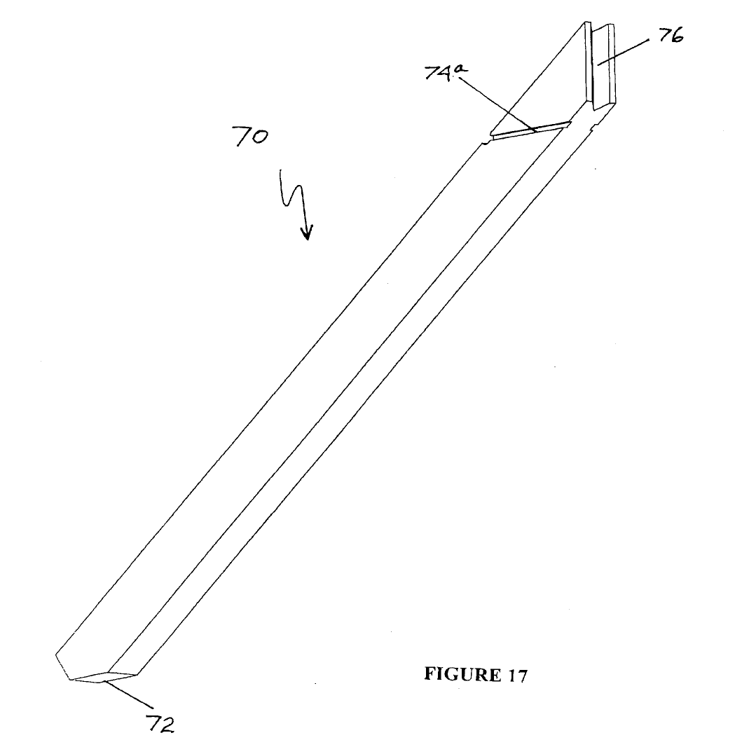

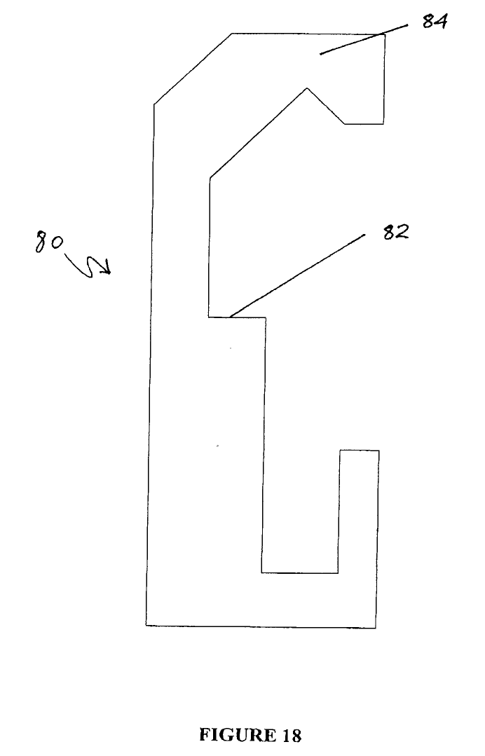

FIGS. 16 and 17 show two views of leg 70. (Leg 68 is the same, except shorter.) Leg 70 has cut off portion 72 to provide a flat ground-contacting area. Grooves 74a and 74b accommodate plate 80 (FIG. 18). Leg 70 includes angle 76 to fit around a corner of post 48, as shown in FIGS. 9 and 11 and act as the brace means.

Plate 80 in FIG. 18 is a unitary metal structure which includes hook means in the form of hook 84. Plate 80 is laser cut and designed to be easily removed from timber leg 70 (or 68) for packing and storage.

As can be seen in FIG. 9, plate 80 is substantially horizontal in use when mounted on leg 68 or 70.

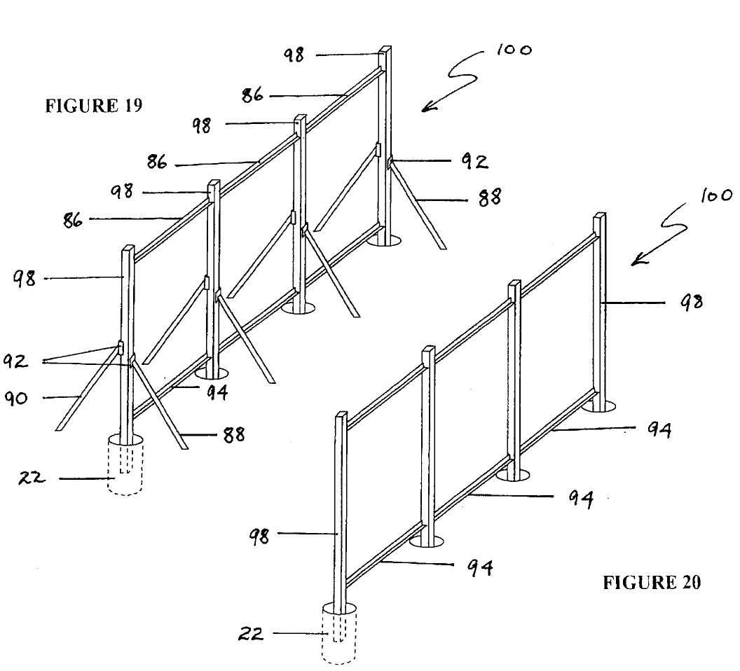

In FIG. 19, legs 88 and 90 are shown symbolically as straight but they are actually similar to legs 6 and 68 of FIG. 9 and have plates like plate 80. These are shown symbolically in FIG. 19 at 92. Because fence 100 has lower rails 94, only two post supports for post 98 are needed. Fence 100 has also upper rails 86 which assist in supporting posts 98.

It will be appreciated by one skilled in the art that in the post support system of the invention the hook means in conjunction with the brace means causes the legs to hook onto the post, so that the post is held in position virtually by its own weight. The legs radiate out from the post: when there are three legs they are preferably spaced evenly around 360 degrees. When there are two legs and the post is partly supported by a rail in one plane, the two legs preferably provide stability in the other plane.

The contact between the leg and the post—via the hook means and the brace means—is such that when the leg is loaded up with the weight of the post the post is gripped. When the weight of the post is taken off the leg, for example by tilting the post away from the leg, it is possible to slide the leg along the post.

As will be apparent to one skilled in the art, the tolerances between the brace means/hook means and the post should be sufficient to enable the post to be held by friction in the manner described above, but that the fit should not be so tight as to crush the post.

As will be apparent to one skilled in the art, the roughly vertical spacing distance between the brace means/hook means should be designed to enable the post to be held by friction in the manner described above, but that the spacing should not be so close together as to crush the post when the support takes its share of the weight.

Protective material or padding, preferably closed cell polymers may be used to protect the surface coating (powder coating or other) from damage by the brace means/hook means, without reducing the friction, enabling the post to be held by the padded means in the manner described above.

In one view, the invention can be expressed as follows:
1. There are 3 post supports which cantilever off the posts and contact the ground.
2. The post itself does not touch the ground.
3. Each post support acts as a cantilever when taking its share of the weight, but when not under load it can be slid along the post easily.
4. This is achieved by the hook and brace joint joining the post and the post support.
5. By virtue of adjusting the height relative to the post of each post support and by virtue of being able to move the structure as a whole on the ground—the post can be simply maneuvered to its desired position.

### INDUSTRIAL APPLICABILITY

Using the post support system of the invention, a post may be quickly and easily positioned—even suspended above the ground—and held in that position until concrete or the like has set the post. The post supports can then be easily and quickly dismantled and set up again for positioning a different post, along the same fence or at a different job.

The system of the invention can provide very stable support and can be assembled and dismantled by one person. The system of the invention can save time and labour. It can allow for different terrain heights since the post supports may be easily adjusted. It can allow for different post angles.

1. A post support including:
means for contacting a surface in or on which the post is to be set;
brace means for contacting the post; and
hook means for embracing the post.

2. The post support of claim 1, wherein the means for contacting the surface includes a leg, having a surface-contacting end and a post-contacting end.

3. The post support of claim 2, wherein the leg is either substantially linear or forms an angle having, in use, a substantially horizontal part and a substantially vertical part.

4. The post support of claim 3, wherein the brace means and the hook means are formed as part of or are connected to the post-contacting end.

5. The post support of claim 1, wherein the brace means and the hook means are combined in a unitary structure.

6. The post support of claim 4, wherein the brace means and the hook means are in use either substantially horizontal or inclined at an acute angle to the vertical.

7. A post support system which includes a plurality of post supports of claim 1.

8. The post support system of claim 7, wherein there are three of the post supports, each having a leg which forms an angle and having, in use, a substantially horizontal part and a substantially vertical part.

9. The post support system of claim 8, wherein each of the three post supports has a vertical part of a different length.

10. The post support system of claim 9, wherein one of the post supports has brace means and hook means which are a mirror reverse of another.

11. The post support system of claim 7, wherein there are two of the post supports, one having a leg which is substantially linear and the other having a leg which forms an angle and having, in use, a substantially horizontal part and a substantially vertical part.

12. The post support system of claim 11, wherein one of the post supports has brace means and hook means which is different from those of the other.

13. The post support system of claim 12, which includes a third post support having a leg which is substantially linear.

14. A method of supporting a post in a chosen position including the steps of:
(a) holding the post in a position similar to the chosen position;
(b) attaching to the post a plurality of post supports as claimed in any one of claims 1 to 6;
(c) tilting the post away from one of the post supports while the post is still supported by the other post support or supports, to move the post closer to the chosen position;
(d) adjusting the height of the post to that of the chosen position and restoring the post to attachment by the one post support; and
(e) adjusting the surface contacting means of the post supports until the post is in the chosen position.

15. The method of claim 14, wherein the surface contacting means includes a leg and step (e) is effected by lifting the leg.

16-17. (canceled)

18. The post support of claim 5, wherein the brace means and the hook means are in use either substantially horizontal or inclined at an acute angle to the vertical.
